(19) United States
(12) Patent Application Publication
(10) Pub. No.: US 2024/0367290 A1
(43) Pub. Date: Nov. 7, 2024

(54) TRAIN AND METHOD OF CLEANING A RAILHEAD

(71) Applicants: LNT Solutions Limited, Garforth Leeds, Yorkshire (GB); CONSUS ANT STATIONARY CUTTING SOLUTIONS GMBH, Lübeck (DE)

(72) Inventors: Tanya BALL, Garforth Leeds, Yorkshire (GB); Marco LINDE, Lübeck (DE)

(21) Appl. No.: 18/568,380

(22) PCT Filed: Jun. 9, 2022
(86) PCT No.: PCT/GB2022/051443

§ 371 Date: Dec. 8, 2023

(30) Foreign Application Priority Data
Jun. 10, 2021 (GB) 202108336.5
Dec. 8, 2021 (GB) 2117743.1

(51) Int. Cl. B24C 3/06; B24C 7/00; E01B 31/18; E01H 8/10

(52) U.S. Cl. CPC B24C 3/06; B24C 7/0007; E01B 31/18; E01H 8/105

(57) ABSTRACT

A method of cleaning a railhead uses a high pressure water abrasive slurry system. A slurry including an abrasive particulate and water is applied to the railhead at a pressure of at least 350 bar. A train incorporates an apparatus for cleaning a railhead, which includes a slurry mixing unit configured to contain a slurry including an abrasive particulate and water. At least one nozzle is in fluid communication with the slurry mixing unit. The at least one nozzle is configured to apply the slurry to the railhead at a pressure of at least 350 bar.

### CROSS REFERENCE TO RELATED APPLICATIONS

This application is a United States National Phase Application of International Application PCT/GB2022/051443, filed Jun. 9, 2022, and claims the benefit of priority under 35 U.S.C. § 119 of Great Britan application Ser. No. 20/210,8336.5, filed Jun. 10, 2021, and Great Britan Application 2117743.1, filed Dec. 8, 2021, the entire contents of which are incorporated herein by reference.

### TECHNICAL FIELD

This invention relates to a method of cleaning a railhead using a high pressure water abrasive slurry system (HPWASS).

### BACKGROUND

Every autumn rail networks in temperate climates suffer from passenger train delays when the heat and weight of passing trains bake fallen leaves into a thin, slippery layer on the rail that is very difficult to remove. This is the black ice of the railway.

This layer causes two problems; 1) when damp it makes the rail extremely slippery and makes it hard for trains to accelerate and brake effectively, and b) it insulates the trains' wheels from the electrical parts of the track that help controllers pin-point where trains are. The cumulative effect is train delays and cancellations. There are also safety issues, for example station overruns and signals passed at danger (SPADs) due to low adhesion.

In the UK, this costs the national provider Network Rail (NWR) in the region £15-£23 million per autumn season.

To mitigate against these leaf-fall issues, Network Rail every day send out 63 specialist treatment trains to remove leaf mulch by jet-washing the rail at very high pressure (high pressure water jetting, applied at 1490 bar and 90 liters/min and deployed on trains travelling at speeds of up to 60 mph). Over the autumn period these vehicles use 180 million liters plus of UK drinking water to treat over 900,000 miles of track trying to remove black crushed leaves.

The use of potable water, often requiring delivery to depot by road hauler, is necessary due to the sensitivity of current water jetting nozzles.

The range of a treatment train is limited by the amount of water it can carry, resulting in sections of track left untreated that planners would ideally treat if the resource was available. Indeed, the demand from stakeholders to treat more track more often is increasing by 10% every year.

Known systems can rely on ‘entrainment’ in that abrasive is sucked in to a flow of water according to the Venturi principle. However, this leads to a high air content within the resultant jet (for example about 95 vol. percent), which results in turbulent mixing losses. In addition, such systems tend to block at high train/vehicle speeds, limiting the amount of track that can be cleaned in a given time. Generally, ‘entrainment’ systems are better suited to cutting applications. In this manner, when such systems are instead used for cleaning applications the high operational pressures can lead to damage of the rail—for example scratching.

### BRIEF SUMMARY OF THE DISCLOSURE

### Abrasive Water-Jetting (AWJ)

This present invention relates generally to a water/abrasive mix deployed at low pressure as an alternative to the high pressure water jetting currently used. The combination of an abrasive delivered at low pressure through the medium of water can be 10× more powerful than plain water jets. This provides the opportunity to improve cleaning performance and dramatically reduce the water usage at the same time. The reduction in water usage may be as much as 80%, which in itself brings significant environmental benefits. In addition, it is not necessary for the water to be potable thereby reducing if not eliminating the need to truck water by road to depot as trains can obtain water from trackside sources.

According to the present invention, the range of the treatment train is no longer limited by the amount of water it can carry, only by the number of hours in the day and component wear. As less water is required in the methods of the invention than conventional high pressure water systems, planners are able to treat considerably more miles of track in a 24 hour treatment period, thereby providing a cleaner rail to the network and directly reducing passenger and freight vehicle delay minutes and improve safety.

Apparatuses of the invention may provide a ‘suspension’ water-abrasive system. That is, a suspension of water and abrasive is created and then applied to the rail. This is in contrast to standard ‘entrainment’ water-abrasive systems where the slurry is created during application to the rail. By first creating the slurry, the abrasive particles are wrapped in the carrier water. The resulting jet is therefore much more stable and precise than that produced by entrainment, such that the same cleaning effect can be achieved at lower pressure.

Apparatuses of the invention may be even more powerful than standard ‘entrainment’ water abrasive systems and remove the risk of potential blockages. For example, apparatuses of the invention may achieve higher performance at lower pressures compared to standard ‘entrainment’ water abrasive systems.

Equipment may be integrated with different remote operation and control strategies.

On UK railways a coefficient of friction of 0.12μ is required for train braking and traction. An aim of this invention is to provide a system by which any contamination adhering to the track is cleaned away and the coefficient of friction restored to 0.12μ.

As with any cleaning operation, the different material properties between the leaf deposit/general railhead contamination and the steel rail, and the respective bonding between the two can vary. The selection of the abrasive and the other water jet parameters (such as flow, pressure, standoff, nozzle etc.) largely determines the effectiveness of the removal process.

As the cleaning will typically be performed by a train moving at 40-60 mph there is little dwell time for the current water jet system to remove contamination. For reasons discussed above, cleaning at such speeds is not effective with standard ‘entrainment’ systems.

According to a first aspect of the present invention, there is provided a method for cleaning a railhead, comprising:
(i) applying a slurry comprising an abrasive particulate and water to the railhead at a pressure of at least 350 bar, wherein the abrasive particulate has a hardness of at least 6.5 on the Mohs scale.

The method may further comprise the following steps before applying the slurry to the railhead:
(i) storing the abrasive particulate in a first container;
(ii) storing water in a second container;
   wherein the first container and second container are each in fluid communication with the slurry mixing unit; and
(iii) mixing the abrasive particulate and water to form a slurry in the slurry mixing unit.

In an embodiment the abrasive particulate and water are mixed in the slurry mixing unit to form a slurry prior to application of the slurry to the railhead. That is, the slurry mixing unit provides a third container that is separate from the flow of water from the second container to an application nozzle.

In an embodiment the step of mixing the abrasive particulate and water to form a slurry comprises:
passing water from the second container to at least one nozzle along a conduit;
bypassing a portion of the water passing along the conduit, wherein the bypassed water is passed to the slurry mixing unit;
mixing the bypassed water with abrasive particulate in the slurry mixing unit to form the slurry; and
transferring the slurry from the slurry mixing unit to the conduit.

In an embodiment, the abrasive particulate has a hardness of at least 7.0 on the Mohs scale. In an embodiment, the abrasive particulate has a hardness of at least 7.5 on the Mohs scale.

In an embodiment, the abrasive particulate has a hardness in the range of 6.5 to 7.5 on the Mohs scale. In an embodiment, the abrasive particulate has a hardness in the range of 6.5 to 7.0 on the Mohs scale. In an embodiment, the abrasive particulate has a hardness in the range of 7.0 to 7.5 on the Mohs scale.

In an embodiment, the abrasive particulate is selected from the group consisting of: garnet, olivine and kiln dried olivine.

In an embodiment, the abrasive particulate is garnet. In an embodiment, the abrasive particulate is alluvial garnet. The inventors have found that alluvial garnet is preferable to rock garnet for cleaning railheads. The less angular alluvial particles are effective at cleaning the rail head but cause less scratching of the metal itself.

In an embodiment, the abrasive particulate is olivine. In an embodiment, the abrasive particulate is kiln dried olivine.

For example, the abrasive particulate may be kiln dried olivine with a hardness of at least 7 on the Mohs scale.

In an embodiment, the abrasive particulate has a particle size of between 250 mesh and 50 mesh.

The abrasive particulate may have a particle size of between 100 mesh and 140 mesh.

The abrasive particulate may have a particle size of between 150 mesh and 50 mesh. The abrasive particulate may have a particle size of about 120 mesh.

The abrasive particulate may have a particle size of about 80 mesh.

The abrasive particulate may be garnet with a particle size of about 80 mesh.

The abrasive particulate may have a particle shape that is sub-angular. A benefit associated with using a particle shape that is sub-angular is that it enhances the cleaning effect by cutting through debris on the railhead but does not scuff the rail head.

The abrasive particulate may be rounded, i.e., substantially non-angular.

In an embodiment, the water used in the method of the invention is non-potable water.

In an embodiment, the water used in the method of the invention is non-demineralized water.

The slurry may be applied to the railhead via at least one nozzle. For example, the slurry may be applied to the railhead via one, two, three or four nozzles per rail.

In an embodiment, the slurry may be applied to the railhead via one or two nozzles per rail. The nozzle may be positioned to apply the slurry at an angle to the rail head to provide improved contaminant removal. The angle may be less than 90 degrees between the nozzle and the rail head. For example, the angle may be between 30 and 90 degrees between the nozzle and the rail head. The angle may be between 45 and 90 degrees between the nozzle and the rail head. (For example, see FIG. 1 which shows an angle of 45 degrees between the nozzle and the rail head and FIG. 2 which shows an angle of 90 degrees between the nozzle and the rail head).

As the treatment train is bidirectional, there may be a first set of one or two nozzles angled to be effective in cleaning the railhead in one direction of travel and a second set of one or two nozzles angled to be effective in cleaning the railhead in the opposite direction of travel. The treatment train may swap between use of the first set of one or two nozzles and the second set of one or two nozzles depending on the direction of travel over the railhead.

The nozzle may be positioned at a distance between 5 and 10 cm from the rail head when cleaning. The nozzle may be positioned at a distance between 7 and 9 cm from the rail head when cleaning. The nozzle may be positioned at a distance of approximately 7 cm from the rail head when cleaning.

In an embodiment, the nozzle may apply the slurry to the railhead in an area of at least 3 cm diameter. In an embodiment, the nozzle may apply the slurry to the railhead in an area of at least 3.5 cm diameter. In an embodiment, the nozzle may apply the slurry to the railhead in an area of at least 4 cm diameter. In an embodiment, the nozzle may apply the slurry to the railhead in an area of at least 4.5 cm diameter. (For example, see FIG. 4.)

In an embodiment, the nozzle may apply the slurry to the railhead in an area of between 3 and 4.5 cm diameter. In an embodiment, the nozzle may apply the slurry to the railhead in an area of between 3.5 and 4.5 cm diameter. In an embodiment, the nozzle may apply the slurry to the railhead in an area of between 4.0 and 4.5 cm diameter.

In an embodiment, the nozzle may apply the slurry to the railhead in an area of about 4.5 cm diameter.

Alternatively, two or more nozzles may apply the slurry to the railhead over a combined area of at least 3 cm diameter. In an embodiment, the two or more nozzles may apply the slurry to the railhead over a combined area of at least 4.5 cm diameter.

In an embodiment, the two or more nozzles may apply the slurry to the railhead over a combined area of about 4.5 cm diameter.

For example, two nozzles may apply the slurry to the railhead over a combined area of at least 3 cm diameter. In an embodiment, the two nozzles may apply the slurry to the railhead over a combined area of at least 4.5 cm diameter. In an embodiment, the two nozzles may apply the slurry to the railhead over a combined area of about 4.5 cm diameter.

The nozzle may have a slurry flow rate of at least 0.5 L per minute. The nozzle may have a slurry flow rate of at least 1 L per minute. The nozzle may have a slurry flow rate of at least 2 L per minute. The nozzle may have a slurry flow rate of at least 3 L per minute. For example, the nozzle may have a slurry flow rate of at least 4 L per minute. For example, the nozzle may have a slurry flow rate of at least 5 L per minute.

The nozzle may have a slurry flow rate of less than 10 L per minute. The nozzle may have a slurry flow rate of less than 9 L per minute. Alternatively, the nozzle may have a slurry flow rate of less than 8 L per minute. For example, the nozzle may have a slurry flow rate of less than 7 L per minute. For example, the nozzle may have a slurry flow rate of less than 6 L per minute. For example, the nozzle may have a slurry flow rate of less than 5 L per minute. The nozzle may have a slurry flow rate of at least 0.5 L per minute.

In an embodiment, the nozzle may have a slurry flow rate of 0.5 to 10 L per minute. In an embodiment, the nozzle may have a slurry flow rate of 0.5 to 9 L per minute. In an embodiment, the nozzle may have a slurry flow rate of 0.5 to 8 L per minute. In an embodiment, the nozzle may have a slurry flow rate of 0.5 to 7 L per minute. In an embodiment, the nozzle may have a slurry flow rate of 0.5 to 6 L per minute. In an embodiment, the nozzle may have a slurry flow rate of 0.5 to 5 L per minute.

For example, in an embodiment, the nozzle may have a slurry flow rate of 1 to 9 L per minute. In an embodiment, the nozzle may have a slurry flow rate of 2 to 8 L per minute. In an embodiment, the nozzle may have a slurry flow rate of 3 to 7 L per minute. In an embodiment, the nozzle may have a slurry flow rate of 4 to 6 L per minute.

The nozzle may have a slurry flow rate of between 5 and 8 L per minute. The nozzle may have a slurry flow rate of between 5.5 and 7.5 L per minute. The nozzle may have a slurry flow rate of about 7.5 L per minute. The nozzle may have a slurry flow rate of about 5.5 L per minute.

The slurry may comprise between 0.02 and 0.8 kg of abrasive particular per 1 L of water.

In an embodiment, the slurry may comprise at least 0.02 kg of abrasive particulate per 1 L of water. The slurry may comprise at least 0.1 kg of abrasive particulate per 1 L of water. The slurry may comprise at least 0.2 kg of abrasive particulate per 1 L of water. The slurry may comprise at least 0.3 kg of abrasive particulate per 1 L of water. The slurry may comprise at least 0.4 kg of abrasive particulate per 1 L of water. The slurry may comprise at least 0.5 kg of abrasive particulate per 1 L of water.

In an embodiment, the slurry comprises less than 0.8 kg of abrasive particular per 1 L of water. For example, the slurry may comprise less than 0.7 kg of abrasive particulate per 1 L of water. Alternatively, the slurry may comprise less than 0.6 kg of abrasive particulate per 1 L of water. The slurry may comprise at least 0.02 kg of abrasive particulate per 1 L of water.

In an embodiment, the slurry may comprise between 0.1 and 0.5 kg of abrasive particulate per 1 L of water.

In an embodiment, the slurry may comprise 0.5 kg of abrasive particulate per 1 L of water, for example 5 kg of abrasive particulate per 10 L water.

The slurry may comprise between 0.1 and 0.25 kg of abrasive particulate per 1 L of water.

The amount of the abrasive applied to the rail may be between 200 and 1200 g per minute. The amount of the abrasive applied to the rail may be between 300 and 1000 g per minute. The amount of the abrasive applied to the rail may be amount of the abrasive applied to the rail may be between 500 and 700 g per minute. The amount of the abrasive applied to the rail may be between 300 and 600 g per minute. The amount of the abrasive applied to the rail may be about 680 g per minute. These values are the amount of abrasive applied to a single rail.

The amount of water applied to the rail may be between 3 and 8 liters per minute. The amount of water applied to the rail may be between 4 and 6.5 liters per minute. These values are the amount of abrasive applied to a single rail.

The first container and the second container will typically be at atmospheric pressure. The third container will typically be at a pressure greater than atmospheric pressure. For example, the pressure of the third container may be between 300 and 1200 bar.

In an embodiment, the slurry is applied to the railhead at a pressure of at least 500 bar. In an embodiment, the slurry is applied to the railhead at a pressure of at least 700 bar. In an embodiment, the slurry is applied to the railhead at a pressure of at least 1000 bar. In an embodiment, the slurry is applied to the railhead at a pressure of at least 1200 bar.

In an embodiment, the slurry is applied to the railhead at a pressure of an upper limit of 1500 bar. In an embodiment, the slurry is applied to the railhead at a pressure of an upper limit of 1200 bar. In an embodiment, the slurry is applied to the railhead at a pressure of an upper limit of 1000 bar. In an embodiment, the slurry is applied to the railhead at a pressure of an upper limit of 700 bar. In an embodiment, the slurry is applied to the railhead at a pressure of an upper limit of 500 bar. The slurry may be applied to the railhead at a pressure of at least 500 bar.

In an embodiment, the slurry is applied to the railhead at a pressure in the range 350 to 1500 bar. In an embodiment, the slurry is applied to the railhead at a pressure in the range 500 to 1500 bar. In an embodiment, the slurry is applied to the railhead at a pressure in the range 700 to 1500 bar. In an embodiment, the slurry is applied to the railhead at a pressure in the range 1000 to 1500 bar. In an embodiment, the slurry is applied to the railhead at a pressure in the range 1200 to 1500 bar.

In an embodiment, the slurry is applied to the railhead at a pressure in the range of 350 to 1200 bar. In an embodiment, the slurry is applied to the railhead at a pressure in the range of 700 to 1200 bar. In an embodiment, the slurry is applied to the railhead at a pressure in the range of 700 to 1000 bar.

In an embodiment, the slurry is applied to the railhead at a pressure in the range 700 to 1500 bar.

In an embodiment, the water is pumped into the slurry mixing unit via a high pressure pump. The water may be pumped into the slurry mixing unit at a maximum pressure of 1500 bar.

In an embodiment, the water is pumped into the slurry mixing unit via a high pressure pump. The water may be pumped into the slurry mixing unit at a maximum pressure of 700 bar.

Preferably, the slurry is applied to the railhead at a pressure that does not result in erosion of the railhead. This will depend on the selection of a particular abrasive, particle size, concentration of abrasive and train speed. The inventors have found that at certain speeds, use of garnet at 80 mesh should be applied to the railhead at less than 1500 bar to avoid erosion of the railhead.

In an embodiment, the abrasive particulate is stored dry in the first container. The abrasive particulate may be transferred to the slurry mixing unit via a continuous flow.

The slurry mixing unit may be an abrasive mixing unit (AMU).

In an embodiment, the cleaning of the railhead may be performed by a train travelling at least 40 mph. In an embodiment, the cleaning of the railhead may be performed by a train travelling at least 50 mph.

In an embodiment, the cleaning of the railhead may be performed by a train travelling at an upper limit of 60 mph. In an embodiment, the cleaning of the railhead may be performed by a train travelling at an upper limit of 50 mph. The cleaning of the railhead may be performed by a train travelling at least 40 mph.

In an embodiment, the cleaning of the railhead may be performed by a train travelling at between 40 and 60 mph.

In an embodiment, the railhead is cleaned until a coefficient of friction of 0.2μ is reached. The term “container” is understood to hold a substantial amount of the abrasive particulate, water and/or slurry, for example up to 30000 L. The term “container” is not intended to encompass a tube-like conduit.

The “container” may hold for example, between 10 and 30000 L. Optionally, the “container” may hold between 10 and 20000L, for example between 10 and 10000 L.

In an embodiment, the second container may hold up to 15000 kg of the abrasive particulate.

According to a second aspect of the present invention, there is provided a train incorporating an apparatus for cleaning a railhead according to the method of the first aspect of the present invention, the apparatus comprising:
a slurry mixing unit configured for containing a slurry comprising an abrasive particulate and water; and
at least one nozzle in fluid communication with the slurry mixing unit,
wherein the at least one nozzle is configured to apply the slurry to the railhead at a pressure of at least 350 bar.

The apparatus may further comprise:
(i) a first container configured for containing an abrasive particulate; and
(ii) a second container configured for containing water;
   wherein the slurry mixing unit is in fluid communication with each of the first container and the second container.

In an embodiment the slurry mixing unit is a third container that is separate from the flow of water from the second container to the at least one nozzle.

In an embodiment the apparatus further comprises:
a primary conduit fluidly coupling the second container to the at least one nozzle; and
at least one secondary conduit, or bypass conduit, fluidly coupling the primary conduit to the slurry mixing unit.

In an embodiment, the first container comprises an abrasive particulate, wherein the abrasive particulate has a hardness of at least 6.5 on the Mohs scale.

In an embodiment, the second container comprises water.

In an embodiment, the slurry mixing unit comprises a slurry of the abrasive particulate and water.

In an embodiment, the pump is a high pressure pump.

The high pressure pump may operate at a pressure between 700 and 1500 bar. The high pressure pump may be configured to pump between 2 and 25 L of the slurry per minute from the slurry mixing unit to the at least one nozzle.

The apparatus may further comprise a pump drive system. The pump drive system may be a diesel with an electric starter.

Additionally, the apparatus may further comprise a hydraulic power unit.

The apparatus may also further comprise an automated refill. In addition, the apparatus may further comprise a GPS control system. The GPS control system may be configured to control the turning on and turning off of the water jet system as the train goes over switches and crossings.

In an embodiment, the train may perform the cleaning of the railhead while travelling at least 40 mph. In an embodiment, the train may perform the cleaning of the railhead while travelling at least 50 mph.

In an embodiment, the train may perform the cleaning of the railhead while travelling at an upper limit of 60 mph. In an embodiment, the train may perform the cleaning of the railhead while travelling at an upper limit of 50 mph. The train may perform the cleaning of the railhead while travelling at least 40 mph.

In an embodiment, the train may perform the cleaning of the railhead while travelling at between 40 and 80 mph, e.g. between 40 and 60 mph.

Furthermore, the embodiments described above in relation to the first aspect of the invention are applicable to the second aspect of the invention.

The cleaning of the railhead may be performed at approximately 60 mph.

According to a third aspect of the invention, there is provided a method of retro-fitting a train with an apparatus as defined in the second aspect of the invention.

Embodiments of the invention are further described hereinafter with reference to the accompanying drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view showing application of the slurry to the railhead at 45° to the railhead;

FIG. 2 is a perspective view showing application of the slurry to the railhead at 90° to the railhead;

FIG. 3 is a view showing the pressure at which the slurry is applied to the railhead;

FIG. 4 is a partial perspective view showing the width of the application of the slurry to the railhead;

FIG. 5 is a top view showing the depth of the application of the slurry to the railhead;

FIG. 6 is a top view showing a railhead that has been cleaned from corrosion using application of the slurry;

FIG. 7 is a schematic view that illustrates the arrangement of components in a train;

FIG. 8 is a schematic view showing the full size test rig used to measure the coefficient of friction (CoF) before and after cleaning according to the method of the present invention;

FIG. 9 is a graph showing a creep curve according to the results of Test A; and

FIG. 10 is a schematic view showing an example embodiment of an apparatus for cleaning a railhead.

### DETAILED DESCRIPTION

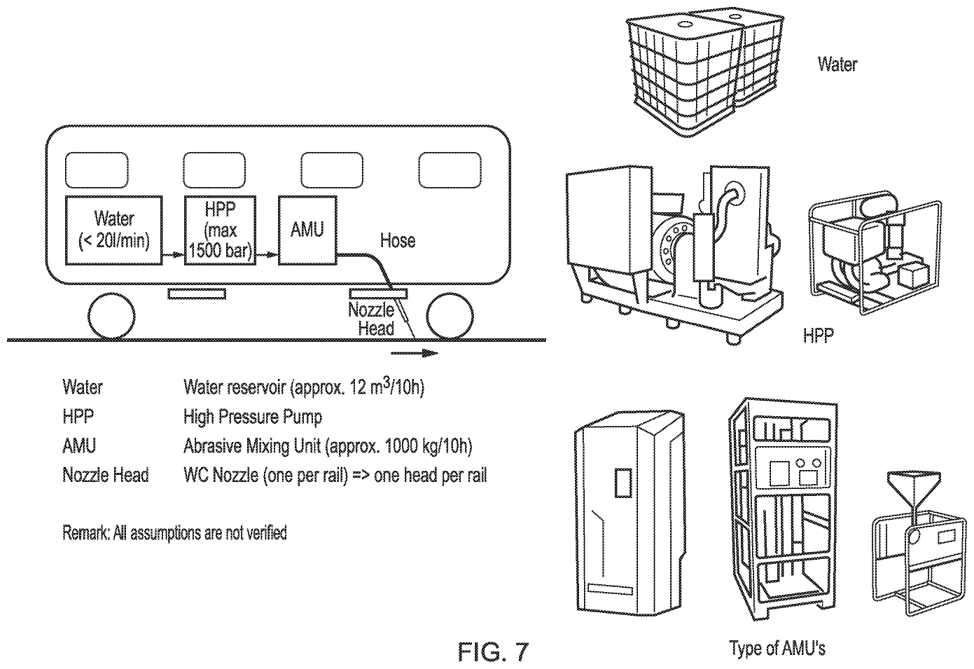

Referring to the drawings, FIG. 7 shows a schematic that illustrates the arrangement of components in a train.

The train comprises a first container comprising an inlet and an outlet. The first container stores water. The water may be potable or demineralized. The water may be is preferably non-potable or non-demineralized. The first container is capable of holding a substantial amount of water, for example the first container may hold up to 30000 L of water and may be in the form of a tank. This is advantageous because the train is able to operate for longer durations and cover more track before re-filling of the first container with water is necessary. It is understood that the term “container” is not intended to encompass a tube-like conduit, such as a pipe or tube. The water is introduced into the first container via the inlet for storage. The first container is typically at atmospheric pressure.

The train also comprises a second container comprising an inlet and an outlet. The

second container stores particulate abrasive. The particulate abrasive is preferably stored dry in the second container. Similarly to the first container, the second container is capable of holding a substantial amount of particulate abrasive, for example the second container may hold up to 30000 L of abrasive particulate and may be in the form of a tank. For example, the second container may hold up to 15,000 kg of abrasive particulate. This is advantageous because the train is able to operate for longer durations and cover more track before re-filling of the second container with abrasive particulate is necessary. It is understood that the term “container” is not intended to encompass a tube-like conduit, such as a pipe or tube. The particulate abrasive is introduced into the second container via the inlet for storage. The second container is typically at atmospheric pressure.

The abrasive particulate used in the cleaning process has a hardness of at least 6.5 on the Mohs scale. For example, the abrasive particulate may be garnet, olivine and kiln dried olivine. The abrasive particulate may be kiln dried olivine with a hardness of at least 7 on the Mohs scale. Preferably, the abrasive particulate may also have a particle size of between 250 and 50 mesh, this provides enhanced cleaning properties when formed in a slurry and applied the railhead. In addition, the abrasive particulate advantageously also has a particle shape that is sub-angular or rounded to enhance the cleaning effect by cutting through debris on the railhead.

The train further comprises a third container. The third container is a slurry mixing unit comprising a first inlet and a second inlet, and an outlet. The first inlet of the third container is in fluid communication with the outlet of the first container, and the second inlet of the slurry mixing unit is in fluid communication with the outlet of the second container. It is understood that the term “container” is not intended to encompass a tube-like conduit, such as a pipe or tube. Water is removed from the first container and pumped into the third container using a high pressure pump up to a pressure of 1500 bar. The abrasive particulate is also removed from the second container and is introduced into the third container via the second inlet in a continuous flow arrangement. The water and abrasive particulate are mixed to form a slurry in the slurry mixing unit. The slurry mixing unit is typically at a pressure greater than atmospheric pressure, for example between 300 and 1200 bar.

Preferably, the slurry comprises between 0.02 and 0.8 kg of abrasive particular per 1 L of water. For example, the slurry may comprise between 0.1 and 0.5 kg of abrasive particulate per 1 L of water.

The slurry mixing unit or the apparatus (including the first container, second container and slurry mixing unit) may be an abrasive mixing unit. The abrasive mixing unit may be ConSus®, big AMU® or MACE®. Preferably, the abrasive mixing unit is ConSus®.

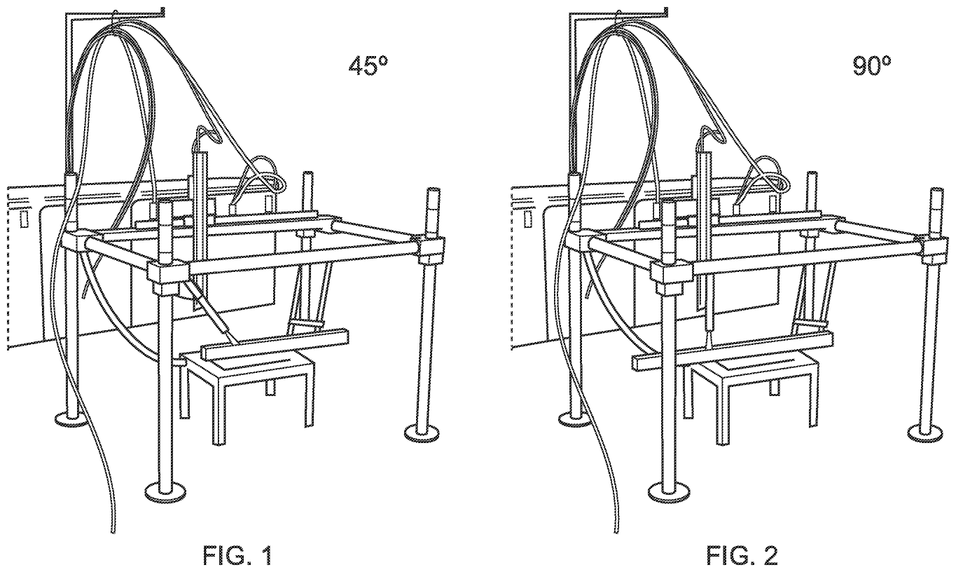

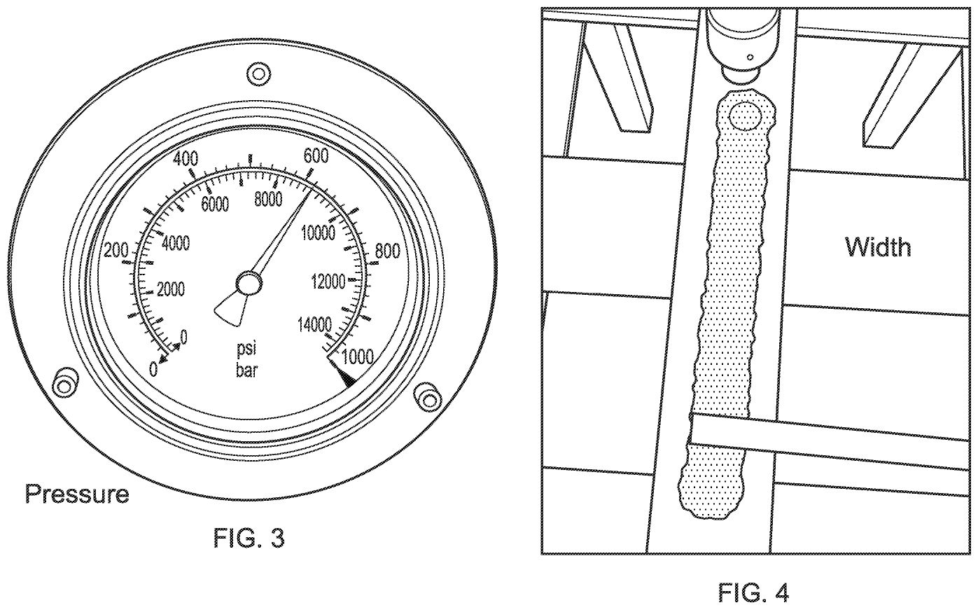

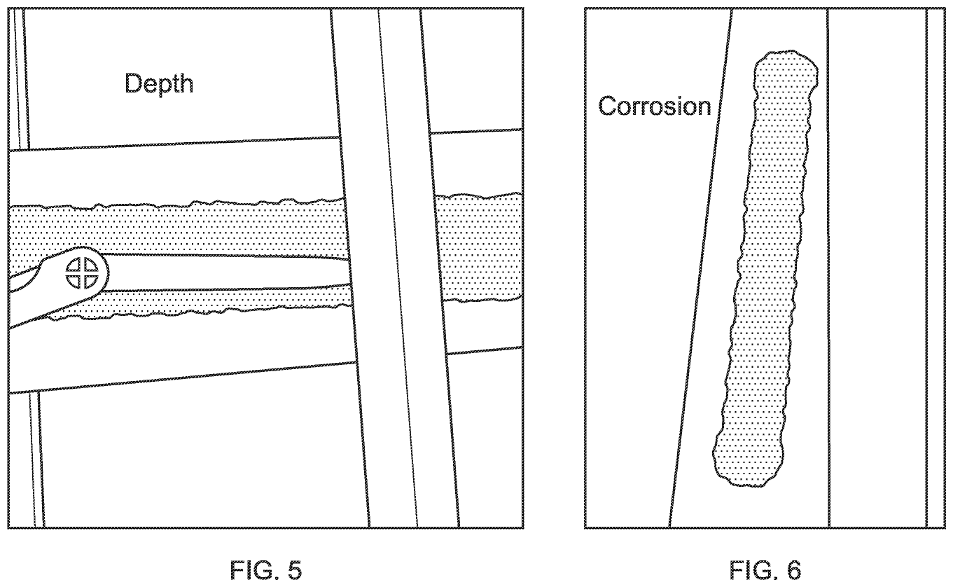

The slurry is removed from the slurry mixing unit via the outlet to at least one nozzle. A high pressure pump may be used to pump the slurry to the nozzle. As mentioned above, the slurry mixing unit may be typically at a pressure greater than atmospheric pressure. The slurry is then applied to the railhead to clean it via the at least one nozzle. Preferably, the slurry is be applied to the railhead via one or two nozzles per rail. The at least one nozzle is preferably positioned to apply the slurry at an angle to the rail head to provide improved contaminant removal. For example, the angle may be less than 90 degrees between the nozzle and the rail head, such as between 30 and 90 degrees between the nozzle and the rail head, or between 45 and 90 degrees between the nozzle and the rail head. The angle may be between 60 degrees and 120 between the nozzle and the rail head, such as between 75 and 105 degrees between the nozzle and the rail head. (For example, see FIG. 1 which shows an angle of 45 degrees between the nozzle and the rail head and FIG. 2 which shows an angle of 90 degrees between the nozzle and the rail head).

The at least one nozzle is typically suitable for emitting a suspension consisting of a fluid and solid particles. The at least one nozzle may be a nozzle with at that comprises an exit opening for the exit of the suspension, characterized in that at least one flow guide element is arranged upstream of the at least one nozzle and comprises a spiral-shaped slow channel, through which the suspension to be emitted is conveyed and thereby is set into rotation. The at least one nozzle is preferably a Surfix® nozzle, available from Applied New Technologies AG and described in EP 1820604 B1.

The nozzle applies the slurry to the railhead in an area of at least 3 cm diameter, preferably, in an area of about 4.5 cm diameter. This enables sufficient cleaning of the railhead. (For example, see FIGS. 4 and 6). The nozzle also has a slurry flow rate of 0.5 to 10 L per minute. In addition, the slurry is applied to the railhead at a pressure in the range 350 to 1500 bar. Preferably, the slurry is applied to the railhead at a pressure in the range 700 to 1500 bar.

Cleaning of the railhead is performed by the train travelling at least 40 mph, for example between 40 and 60 mph. The railhead is cleaned until a coefficient of friction of 0.2μ is reached. Throughout the specification, the ‘pressure’ at which the slurry is applied to the rail head refers to the total pressure across the two rails.

The train of FIG. 7 may include a first apparatus for including a first railhead and a second apparatus for including a second railhead. That is, separate apparatus may be included for cleaning each of the railheads along which the train travels.

Alternatively, the train may include a single apparatus configured to clean both first and second railheads. For example, the slurry mixing unit may be independently coupled to a first nozzle (or a first set of nozzles) for cleaning a first railhead and a second nozzle (or a second set of nozzles) for cleaning a second railhead. In another example, the flow of slurry from the slurry mixing unit may be split into two or more independent streams of slurry, each coupled to at least one nozzle. In each of these examples the apparatus may include means for ensuring even flow in each independent stream. For example, a control system for controlling application of the slurry to the railhead may include a feedback system configured to monitor the flow in each independent stream. Upon detection of a difference between the flow in each independent stream, or a difference above a threshold value, the feedback system may adjust the output of a pump linked to one or more of the independent streams to reduce or remove the difference in flow conditions.

FIG. 10 illustrates an example embodiment of an apparatus 100 for cleaning a railhead. It would be understood that the apparatus of FIG. 10 may be used in the train illustrated in FIG. 7. The apparatus 100 may be an abrasive mixing unit. The abrasive mixing unit may be ConSus®, big AMU® or MACE®. Preferably, the abrasive mixing unit is ConSus®.

The apparatus 100 includes a first container 114 for containing the abrasive particulate and a second container 102 configured for containing water. A third container, slurry mixing unit 106, is in fluid communication with each of the first container 114 and the second container 102. At least one nozzle, in this case a single nozzle 116, is in fluid communication with the slurry mixing unit 106.

In this example the apparatus 100 includes a primary conduit 104 fluidly coupling the second container 102 to the nozzle 116. In use, water is pumped using high pressure pump 103 from the second container 102 through the primary conduit 104 to the nozzle 116. Where the water is non-potable or non-demineralized, it may be that the pump 103 comprises a water filter (not shown).

In this example the apparatus includes a secondary circuit including at least one secondary conduit, or bypass conduit, fluidly coupling the primary conduit 104 to the slurry mixing unit 106. In this example a first secondary conduit 108 is used to bypass a portion of the water from the primary conduit 104 to the slurry mixing unit 106. In use, the bypassed water is mixed with abrasive particulate in the slurry mixing unit 106 to form a slurry.

Once mixed, the slurry in the slurry mixing unit 106 is transferred back to the primary conduit 104 along a second secondary conduit 110. Here the slurry is mixed with, or diluted by, the water flowing along conduit 104. The water and slurry (i.e. the mixture thereof) flows along conduit 110 and is subsequently dispensed from nozzle 116.

In this example the level of abrasive particulate within the slurry mixing unit 106 is maintained to a pre-determined level 118. That is, once abrasive particulate within the slurry mixing unit 106 falls below this level, additional abrasive particulate is fed to the slurry mixing unit 106 from first container 114 along conduit 112. In this example the pre-determined level 118 corresponds to, or is higher than, the inlet of the second secondary conduit 110. In this manner it is ensured that water will be mixed with abrasive particulate prior to passage along the second secondary conduit 110.

In this example a valve 109 is positioned on the first secondary conduit 108. Valve 109 may be closed during the process of filing the slurry mixing unit 106 to the required level.

In this example, the first container 114 and the second container 102 are non-pressurized and may typically be at atmospheric pressure. The slurry mixing unit 106 is kept at an operational pressure greater than atmospheric pressure. For example, the pressure of the third container may be between 300 and 1200 bar.

In certain embodiments an intermediate container may be present between the first container 114 and the slurry mixing unit 106. In use, the intermediate container may receive abrasive particulate from the first container 114, for example at atmospheric pressure. The abrasive particulate may then be pressurized within the intermediate container to a pressure corresponding to that of the slurry mixing unit 106 before being released into the slurry mixing unit 106. The intermediate container may then be de-pressurized for receipt of further abrasive particulate from the first container 114.

The use of an intermediate, pressurizing, container to bring the abrasive particulate to the operational pressure of the slurry mixing unit 106 helps the system to be operated continuously. The slurry mixing unit 106 can be refilled when necessary without a loss of pressure.

In certain embodiments a throttle may be included on conduit 104, downstream of the connection with the first secondary conduit 108, to encourage flow through the first secondary conduit 108.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### EXAMPLES

### Example 1 Test Rail Cleaning With Surfix®

Apparatus was moved very slowly across a sheet of metal, one test for 20 seconds. Data was recorded as provided in Table 1.

| | |
|---|---|
| Editor | Thorsten Rentsch |
| Participants | Marco Linde, Thorsten Rentsch, Matthias Rahn |
| | Tanya Ball (LNT Solutions) |
| WAS System | MACE |
| Manipulation | 3-Axis Cutting Table, MACE Hydraulic |
| System | |

Parameter

| | |
|---|---|
| Abrasive | HPX80 Mass rate 500-600 g/min |
| Pressure | 600-620 bar |
| Nozzle | Ø0.65 mm Surfix-700-0.6S-6L A01.03.01.00.0.00.A |
| Water flow rate | 5 l/min |
| Feeding speed | 280 mm/min |
| Sample | Steel, corroded |

Results

| | |
|---|---|
| Angle 45° | Stand-off 60 mm / 100 mm |
| | Width of machined area 30 mm Depth 200 microns |
| Angle 90° | Stand-off 60 mm |
| | Width of machined area 30 mm |

Table 1 showing parameters of test of apparatus at angle of 45° and 90° between the nozzle and the rail head.

### Summary of Results

Tests validate, at 650 bar pressure, 5 L water and 550 g of particulate abrasive per minute, it was possible to deliver twice the power on one rail compared to current equipment used by Network Rail.

For a 24 hour continual running treatment of both rails—consumables used are water 14,400 L, and particulate abrasive 1,584 kg. With equipment optimization, a reduction of 30-50% in consumables is expected.

### Example 2 Test Rail Cleaning With Test Rig

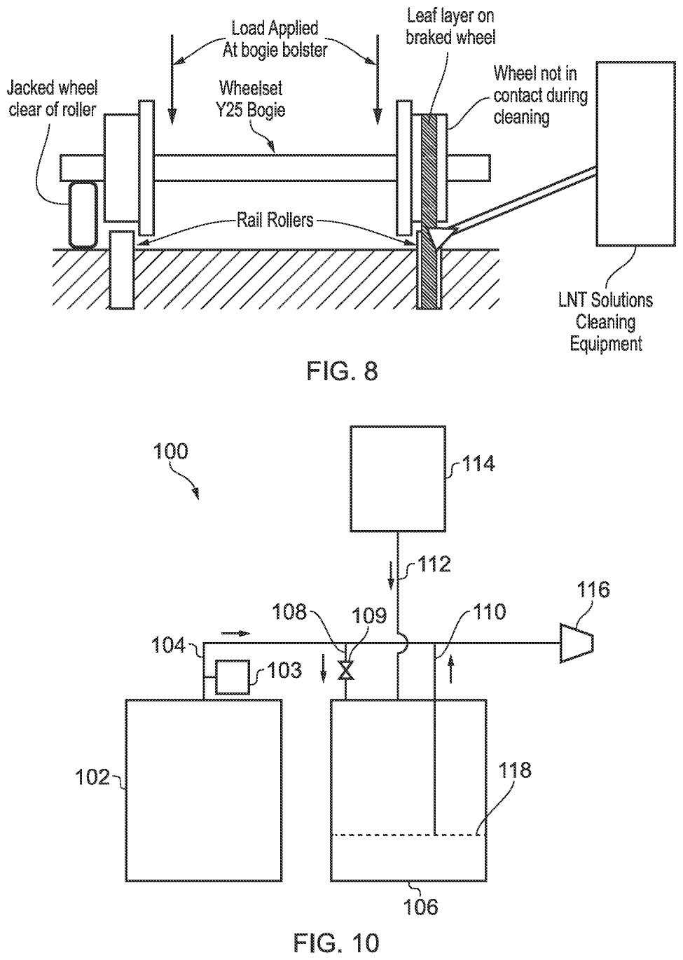

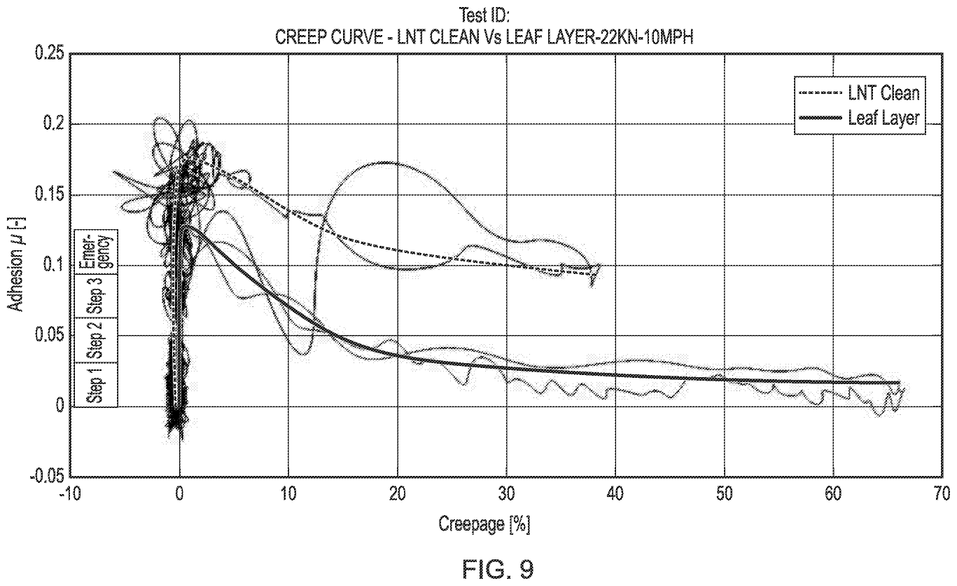

Apparatus was set up in the form of a full size test rig representative of real-life conditions according to FIG. 8. The test rig can be operated at high speed and the bogie can be loaded with representative downward forces.

Trains have different braking forces which are set out as step 1, step 2, step 3 and emergency.

The required CoF for the separate stages is set out below.
Step 1—requires a CoF of between 0 and 0.03μ.
Step 2—requires a CoF of between 0.03 and 0.06μ.
Step 3—requires a CoF of between 0.06 and 0.09μ.
Emergency—requires a CoF of between 0.09 and 0.12μ.

The UK railway requires a CoF of ideally 0.12μ for full emergency braking.

The test rig is instrumented to obtain a coefficient of friction (CoF) reading to enable data to be measured and collected to plot a creep curve at increasing braking levels.

Recently fallen leaves were manually applied to the rail rollers whilst slowly rotating the wheel and roller to establish a leaf layer.

The rig was then accelerated to the required speed and the brakes applied until the pre-set creepage limit was reached and the wheel slide protection (WSP) system vents the brake cylinder. This was repeated until the desired leaf layer resembled a black leaf layer that was well adhered.

The test rig is instrumented to obtain a coefficient of friction (CoF) reading to validate that the black leaf layer gives low friction.

The rail was then cleaned using the method according to the present invention, by application of the slurry comprising an abrasive particulate and water to the railhead via a nozzle (a Surfix® nozzle as described in EP 1820604 B1) using the pressurized water slurry system.

The brakes were then applied again until the pre-set creepage limit is reached and the WSP system vents the brake cylinder. Creep is defined as the difference between wheel and rail speed.

Instrumentation on the test rig also measures the CoF once the rails have been cleaned and friction is restored to normal.

### Test A

The black leaf layer formed on the rail had an average thickness of 25 to 40 microns and

was well adhered to the rail so that it could not easily be scratched off with a sharp instrument. The black leaf layer was formed across the width of the wheel running band.

Test 6 was conducted by applying a slurry containing an abrasive particulate garnet at 80 mesh and a water pressure of 700 bar via a nozzle to clean the rail head. The water flow was 5.5 L per minute and the abrasive flow was 680 g per minute. In addition, the nozzle thread was 20 mm and the distance from the nozzle to the rail was 70 mm. The test speed at which the rail was cleaned was 60 mph.

Following cleaning of the rail head, the CoF was measured again and recorded at 5%, 10%, 15% and 20% creep. The relevant data is presented in Table 1 and FIG. 10.

The rail was inspected following cleaning and all of the black leaf layer had been successfully removed and the cleaning band was measured to be 25 mm wide. There were certain black spots remaining on the rail, but these were not bonded and when removed has a dust-like consistency. The CoF was also shown to have returned to an acceptable level for braking as shown in Table 1.

TABLE 1

| | 10% | | 15% | | 20% | |
|---|---|---|---|---|---|---|
| Test | Before | After | Before | After | Before | After |
| A | 0.08 | 0.14 | 0.05 | 0.16 | 0.04 | 0.17 |

Table 1 provides CoF data relating to Test A before and after cleaning of the rail head at 10%, 15% and 20% creep values.

### Example 3

A qualitative experiment was performed to assess the difference between alluvial garnet and rock garnet.

The experiment was performed using a rig similar to that described above for Example 2. The test was performed by applying a slurry to black leaf layer formed on a rail via a nozzle to clean the rail head. The black leaf layer had an average thickness of 25 to 40 microns and was well adhered to the rail so that it could not easily be scratched off with a sharp instrument. The slurry contained an abrasive particulate garnet water at a water pressure of 750 bar. The water flow was 6.5 L per minute and the abrasive flow was 550 g per minute. The test speed at which the rail was cleaned was 60 mph.

The alluvial garnet rather gave less scuffing to the railhead than rock garnet.

While specific embodiments of the invention have been shown and described in detail to illustrate the application of the principles of the invention, it will be understood that the invention may be embodied otherwise without departing from such principles.

1. A method for cleaning a railhead, the method comprising:
applying a slurry comprising an abrasive particulate and water to the railhead at a pressure of at least 350 bar.

2. The method of claim 1, wherein the abrasive particulate is selected from the group consisting of: garnet, olivine and kiln dried olivine.

3. The method of claim 2, wherein the abrasive particulate is alluvial garnet.

4. The method of claim 1, wherein the abrasive particulate has a particle size of between 250 mesh and 50 mesh and/or the abrasive particulate has a particle shape that is sub-angular or rounded.

5. The method of claim 1, wherein the water is non-potable water or non-demineralized water.

6. The method of claim 1, wherein the slurry is applied to the railhead via one or two nozzles per rail.

7. The method of claim 1, wherein a nozzle applies the slurry to the railhead in an area of at least 3 cm diameter.

8. The method of claim 1, wherein a nozzle applies the slurry to the railhead and the nozzle may have a slurry flow rate of 0.5 to 10 L per minute.

9. The method of claim 1, wherein the slurry comprises between 0.02 and 0.8 kg of abrasive particulate per 1 L of water.

10. The method of claim 1, wherein the slurry is applied to the railhead at a pressure in the range 700 to 1500 bar.

11. The method of claim 1, the method further comprising the following steps before applying the slurry to the railhead:
storing the abrasive particulate in a first container;
storing water in a second container;
wherein the first container and second container are each in fluid communication with a slurry mixing unit; and
mixing the abrasive particulate and water to form a slurry in the slurry mixing unit.

12. The method of claim 10 wherein the step of mixing the abrasive particulate and water to form a slurry comprises:
passing water from the second container to at least one nozzle along a conduit;
bypassing a portion of the water passing along the conduit, wherein the bypassed water is passed to the slurry mixing unit;
mixing the bypassed water with abrasive particulate in the slurry mixing unit to form the slurry; and
transferring the slurry from the slurry mixing unit to the conduit.

13. A train incorporating an apparatus for cleaning a railhead, the apparatus comprising:
a slurry mixing unit configured to contain a slurry comprising an abrasive particulate and water; and
at least one nozzle in fluid communication with the slurry mixing unit,
wherein the at least one nozzle is configured to apply the slurry to the railhead at a pressure of at least 350 bar.

14. A train according to claim 12 further comprising:
a first container configured for containing the abrasive particulate; and
a second container configured for containing the water;
wherein the slurry mixing unit is in fluid communication with each of the first container and the second container.

15. A train according to claim 13, wherein the slurry mixing unit is a third container that is separate from the flow of water from the second container to the at least one nozzle.

16. A train according to claim 13, further comprising:
a primary conduit fluidly coupling the second container to the at least one nozzle; and
at least one secondary conduit, or bypass conduit, fluidly coupling the primary conduit to the slurry mixing unit.

17. A train according to claim 14, further comprising:
a primary conduit fluidly coupling the second container to the at least one nozzle; and
at least one secondary conduit, or bypass conduit, fluidly coupling the primary conduit to the slurry mixing unit.
